(19) United States
(12) Patent Application Publication
(10) Pub. No.: US 2006/0095235 A1
(43) Pub. Date: May 4, 2006

(54) Method of designing automotive seat assemblies for rear impact performance

(76) Inventors: Roland Furtado, Northville, MI (US); Steven J. Reed, Pinckney, MI (US); Mari C. Milosic, Grosse Pointe Park, MI (US)

Correspondence Address: Robin W Asher;Clark Hill, 500 Woodward Avenue, Suite 3500, Detroit, MI, 48226-3435, US

(21) Appl. No.: 10/542,736

(22) PCT Filed: Feb. 3, 2004
(86) PCT No.: PCT/US04/02952

§ 371 Date: Jul. 19, 2005

Related U.S. Application Data
(60) Provisional application No. 60/444,534, filed on Feb. 3, 2003.

(51) Int. Cl. G06F 17/50

(52) U.S. Cl. 703/1

(57) ABSTRACT

A method for designing automobile seat assemblies in which a sled test is run on a prototype seat assembly in order to obtain the necessary data to model the seat assembly with simulation software. A basic model of the surface of the seat assembly is built utilizing simulation software and tests are run on various parameters to determine those that are most significant to the desired objective of the design process. Thereafter, the software is used to build a detailed model of the seat assembly and all its elements and the significant parameters are tested further to determine those that are again most significant to achieving the desired outcome. Once optimization ranges for those most significant parameters are chosen, the prototype seat assembly is modified accordingly. A final sled test is run on the modified prototype to verify the results and compare those results with the original sled test results.

### BACKGROUND OF THE INVENTION

1. Field of the Invention

This invention relates to a method of designing seat assemblies and more particularly, to optimizing automotive seat assemblies for rear impact loads.

2. Description of Related Art

Whiplash is a term commonly associated with automobile collisions. A 1997 Japan Traffic Safety Association report showed that forty-four percent of all automotive-related injuries were neck injuries resulting from rear-impact collisions. (Yoichi Watanabe et al., Influence of Seat Characteristics on Occupant Motion in Low-speed Rear Impacts, Accident Analysis & Prevention, March 2000, 243.) The term “whiplash” is commonly used to describe soft-tissue damage to the cervical spine region of the human neck; however, “whiplash” is actually defined by a three-phase motion path of the head and neck during a rear-end impact. These three phases are (a) the ramping up, where the spine elongates; (b) a rapid rearward acceleration of the head relative to the torso; and (c) hyperextension of the cervical spine. (Watanabe et al. at 244.)

There are a range of potential injuries associated with whiplash, including neck and shoulder pain, headaches, and upper torso radial pain. This is significant since a high number of these injuries are often the result of low velocity rear-end impacts. According to a 1996 study by Eichberger, ninety percent of all rear-impact-related injuries occur in collisions below 25 km/h. (Watanabe et al. at 243.)

Automotive seating companies are continually researching better methods of designing and developing safer automotive seating systems. The prevalent methods of tackling the problem of rear-impact injuries as discussed above, utilize specific components that are added to seating systems after the seat design process. These components are intended to make the seat system respond at the time of the impact. For example, some move the seat rearward at the time of impact while others move the head restraint forward at the time of impact to reduce head movement.

Unfortunately, these systems are reactive in that they attempt to shorten the gap between the head and the head restraint at the onset of a rear impact collision. Therefore, there is a need in the art for a low-cost proactive seat assembly design and development procedure, which reduces the neck loads and potential for whiplash injuries associated with rear impacts. This design and development process should occur during the seat design stage instead of adding extra components to the seat assembly after the design and development process.

### SUMMARY OF THE INVENTION

According to one aspect of the current invention, there is provided a method of designing automotive seat assemblies for meeting a desired objective. The method involves running a sled test on a prototype seat assembly with a test dummy to obtain the necessary data to create a computerized model that will obtain substantially the same results under similar circumstances. Then, a basic model of the seat assembly surface is built on simulation software. Next, the model is validated, using data from the sled test, to ensure that the model is substantially the same as the prototype seat assembly. Once validated, analysis is done to determine which seat parameters are the most significant to meeting the desired design objective. Next, a detailed model of the seat assembly is built on the simulation software, taking into account the elements of the seat assembly and the material properties. This detailed model is then validated against the data from the original sled test to ensure the model is representative of the prototype. Once validated, analysis is performed on those parameters determined to be most significant to the basic model to determine which of those parameters are most significant to the detailed model in meeting the desired objective. The prototype seat assembly is modified according to the analysis of the parameters. Finally, a final sled test is run on the modified seat assembly with the test dummy to obtain the data necessary to show advancement towards the desired objective.

### BRIEF DESCRIPTION OF THE DRAWINGS

Advantages of the present invention will be readily appreciated as the same becomes better understood by reference to the following detailed description when considered in connection with the accompanying drawings wherein:

FIG. 1 is a flow chart of the phases of the instant application of the method of design;

FIG. 2 is a side view of a prototype seat assembly;

FIG. 3 is a side view of a multibody build of a seat assembly with an Anthropomorphic Test Device; and

FIG. 4 is a view of a finite element model build of a seat assembly with an Anthropomorphic Test Device.

### DETAILED DESCRIPTION OF THE PREFERRED EMBODIMENT

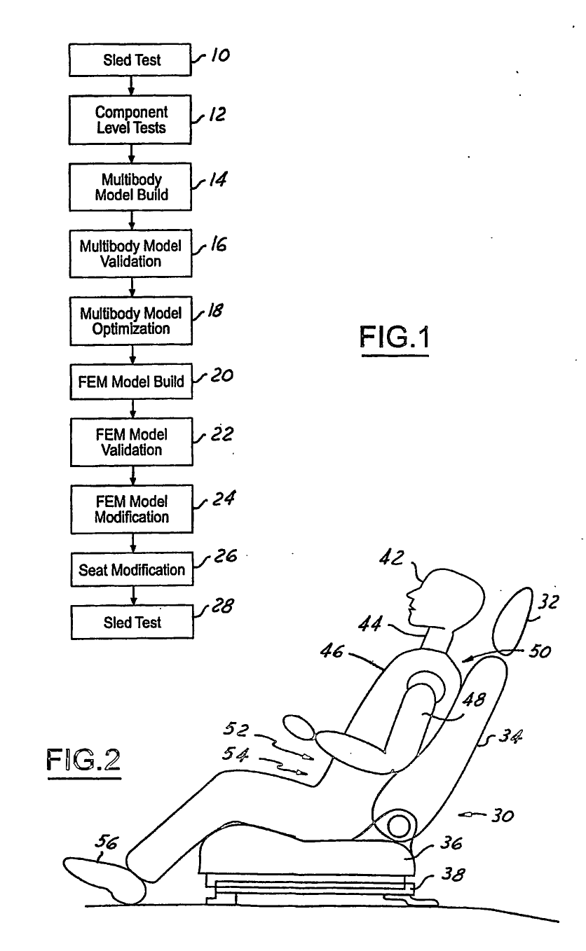

Referring to FIG. 1, a detailed flow chart of the method for designing automotive seat assemblies for the desired objective of improved rear impact performance using computer modeling/simulation software is provided. Preferably, MADYMO, an engineering software tool developed by TNO Automotive, which allows users to design and optimize vehicle structures, components, and safety structures, is used. This method involves four main steps of (1) performing a sled test, (2) building and analyzing models of the seat assembly, (3) optimizing the seat assembly for the desired criteria, and (4) performing a final sled test on the modified seat assembly. It is to be understood that this is a very general outline of the method and each step can be modified/broken down as needed to take into account the goal and specific criterion/objectives of the application. This method will be explained in a more detailed manner, describing the phases involved in the instant application of the method—improving rear impact performance. It is to be understood that many aspects of these steps could be modified, added, or deleted for each individual application/objective while still remaining within the purview of the overall method disclosed herein.

In the instant application of the method, the four main steps were broken down further into ten phases, as shown in FIG. 1 at 10-28. For purposes of illustration, the method will be described according to these ten phases for clearer understanding of how the instant method can be applied to many different objectives.

The method for designing automotive seat assemblies for rear impact performance begins with performing a physical, dynamic rearward sled test on a prototype seat assembly 30 shown generally in FIG. 2. The seat assembly 30 includes a head restraint 32, a seat back 34, a seat bottom 36, and tracks 38. This sled test is required for validation of the computerized model and for certification of the seat 30 in the final phase. The sled test is carried out on a Hyge sled at the selected impact pulse with the desired seat assembly 30 and appropriate Anthropomorphic Test Device hereinafter “dummy”). The dummy 40 includes a head 42, a neck 44, a chest 46, arms 48, a back 50, a pelvis 52, an abdomen 54, and feet 56. Preferably, multiple tests should be carried out using the same setup to ensure the repeatability of the data. The minimum data obtained from the sled test for the current application included: head 42, chest 46 and pelvis 52 accelerations of the dummy 40; neck 44 loads from the dummy 40; a video of the sled test; pre-and post-test seat back 34 angles; backset distance (distance from the back of the dummy head 42 to the front of the head restraint 32); vertical distance from the top of the dummy head 42 to the top of the head restraint 32; overall dummy 40 position with respect to H-point, pelvic angle, torso angle; pictures of deformed members of seat structure; notes of any permanent damage/deformation; and any movement/deflection/deformation of the seat tracks 38.

The second phase 12 in the instant application is to run component level tests. The component level tests provide the data required as input properties to build the multibody model 60 of the seat, as will be discussed later. Preferably, the component tests performed include a seat back 34 structural strength test, a seat bottom 36 cushion structural strength test, a head restraint 32 structural strength test, and a hysteresis test on the seat back 34, the seat bottom 36 cushion, and the head restraint 32 foam. For example, in the tests performed in the current application of the method, different data was required for the various components. For the seat back 34 structural strength test, rearward moment load was applied to the top of the seat back 34, a MTS hydraulic tester was used to apply a load of 100 lbs/sec until the ultimate load was observed, and force vs. deflection and moment vs. angular deflection characteristics were obtained from the component. The component test of the seat bottom 36 cushion structural strength test was substantially similar to that of the seat back 34. The head restraint 32 structural strength test involved determining the performance characteristics of the head restraint 32 and associated structures, applying static load in a rearward direction, applying a loading rate of 25 lbs/sec until the ultimate strength was observed and obtaining force vs. deflection and moment vs. angular deflection characteristics of the components. Finally, the hysteresis test on the seat back 34, seat bottom 36, and head restraint 32 foam to obtain the specific properties of the foam was performed on Instron, but any such device may be used. The seat back 34 was tested in three different regions to obtain properties specific to areas loaded by pelvis 52, abdomen 54, and chest 46 contacts. The bottom 36 cushion was tested in two regions to obtain properties specific to dummy 40 ischial (hip region) and nose contacts. The test loading rate was 5 seconds per cycle.

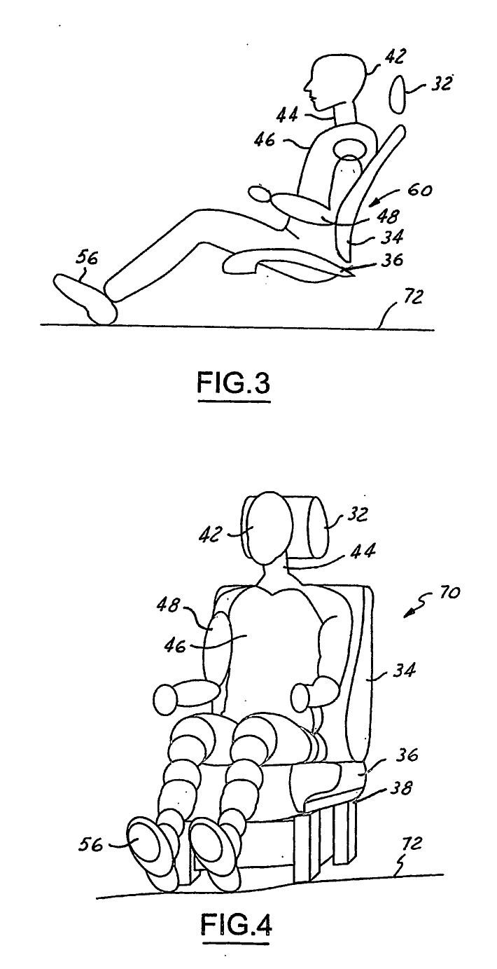

The third phase 14 of the current application of the instant method was to construct the computerized multibody build 60, as shown in FIG. 3. The multibody build 60 of the seat assembly 30 is a basic baseline build of the surface of the seat assembly 30 and does not take into account the specific properties of the materials or the interior individual elements of the seat assembly 30, but it does look at the subassemblies of these parts. Running assimilations on the baseline multibody build is much faster than on a more detailed build and therefore much more cost effective. Preferably, five different aspects of the seat assembly 30 are considered when constructing the multibody build 60, resulting in a five-step construction process.

The first step to constructing the multibody build 60 is to construct the seat geometry. The profile of the seat surface is obtained via laser scan or CAD data and is modeled using that data. The seat surface can be modeled using a variety of shapes, including ellipsoids or facet elements. For the current application, facet elements were used for the modeling due to their ability to most accurately represent the seat geometry. The modeled surface is then attached to a rigid multibody representing the seat back 34 and the seat bottom 36 cushion frame respectively. The head restraint 32 is modeled in a similar fashion.

The second step to constructing the multibody build 60 is to determine the joint type, position, and stiffness in order to represent the connection between the seat back 34, cushion, and head restraint 32. In order to adequately represent the movement and connection between the seat back 34, bottom 36 cushion, and head restraint 32, the proper joints must be used. One skilled in the art will realize that the type of joint will depend on the type of seat assembly being modeled. For the seat used in this application of the method, the seat bottom 36 cushion was connected to the inertia space with a free joint, the seat back 34 and bottom 36 cushion were connected by a one degree of freedom revolute joint, and the head restraint 32 was connected to the seat back 34 with both a one degree of freedom revolute joint and a one degree of freedom translational joint to represent both the rotation of the head restraint 32 as well as the motion of the head restraint 32 in the vertical direction.

The joint stiffness data was gleaned from the structural strength tests performed in the component level tests of the previous phase, phase two. The tests performed isolate each component for force vs. deflection data, providing the necessary information to model the joint stiffness. The joints and associated rigid bodies are then connected and placed in the appropriate position based on the seat design information and the sled test information.

The third step to constructing the multibody build 60 is to model the foam and suspension stiffness. For the current application of the method, the seat bottom 36 cushion was divided into two sections, the ischial region and the seat cushion nose region. The cushion stiffness of each of these regions was obtained by the hysteresis testing on the seat, as described above in the component level testing of the second phase. The seat back 34 cushion was divided into three regions: the seat back 34 lumbar, the seat back 34 middle, and the seat back 34 upper regions. Again, the data for the cushion stiffness of each of these regions was obtained via the hysteresis testing performed on the seat in phase two.

The fourth step to constructing the multibody build 60 is to position the dummy 40 into the modeled seat assembly. The dummy 40 is positioned in the seat based on H-point information and/or gravity. The initial position of the dummy 40 in the seat, before the application of the acceleration pulse, was determined by allowing the dummy 40 to settle in the seat under the force of gravity. The position of the dummy 40 is then crosschecked with the sled test data Next, the model stiffness properties with respect to seat bottom 36 and seat back 34 foam is tuned to get good dummy 40 position. This part of the stiffness curve should not be modified in the kinematics validation of the model. The positions of the H-point and all of the dummy 40 joints at the end of the settling run is noted and used to position the dummy 40 at the correct position each time.

If the modeling software does not ignore penetrations to the modeled seat assembly 60 at time zero (MADYMO does not), then before each rear impact simulation, the dummy 40 is maintained at an initial position away from the seat 60 and with all of its joints locked. Simultaneously, the seat 60 is positioned away from the dummy 40 and with the seat back 34 revolute joint and the head restraint 32 joint locked at the predetermined angle, the seat is moved towards the dummy 40 over the initial 30 ms so that the dummy 40 H-point would be at the correct position in the seat 60. At this time, the dummy 40 joints and the seat recliner and head restraint 32 joints are unlocked by means of a sensor. Finally, the acceleration field for the rear impact simulation commences and the model runs for 300 ms.

The fifth and final step to constructing the multibody build 60 in this application of the method, is to ensure that the contact points between the dummy 40 and the modeled seat assembly 60 are correct. The contacts of concern and verified in this application of the method were the occupant back 50 to the seat back 34 cushion, the occupant lower torso to the seat bottom 36 cushion, the occupant head 42 to the head restraint 32, the occupant arms 48 to the seat back 34, and the occupant feet 56 to the floor 72.

Once a model 60 of the seat assembly 30 with the dummy 40 is completed, the fourth phase 16 of the method is to validate the multibody model 30 with the physical model 30 using the sled test data. This is done to ensure that the model 60 is a correct representation of the actual seat assembly 30. For validation, it is important to be sure that certain signals from the modeled dummy 40 correlate with those same signals obtained from the sled test dummy 40 under the same conditions. Of course, the signals to be correlated may change according to the specific criterion of the specific application.

In the instant application of the method, the following signals were correlated: head 42 longitudinal and vertical accelerations, chest 46 longitudinal accelerations, pelvis 52 longitudinal accelerations, upper and lower neck 44 shear and axial loads, and upper and lower neck 44 moments about the y-axis. While validating the model 60, it is also necessary to tune the recliner revolute joint stiffness, the seat back 34 foam, the seat bottom 36 foam and head restraint 32 foam stiffness properties, and the friction characteristics so as to get the timing and the value of the peak longitudinal head 42, chest 46, and pelvis 52 accelerations of the model to correlate with the sled test data. For the instant application of the method, the correlation between the sled test and the model 60 was considered acceptable if the model response trend was similar to the sled test and when the peak loads were within 15-20% of the tests with respect to magnitude and timings. Of course, this allowance could be modified for other applications of the method. Once the multibody model 60 is constructed and validated, the testing and optimization may begin.

The fifth phase 18 of the current application of the instant method involves optimizing the multibody model 60 for the desired results. First, the parameters that have the potential to influence the dummy 40 response in rear impacts are identified. For the current application, the list of parameters included the backset (horizontal distance from back of head 42 to front of head restraint 32), the vertical distance from the top of head to top of head 42 restraint 32, the recliner pivot position, the seat back 34, recliner, and master bracket stiffness, the head restraint 32 structure stiffness, the seat back 34, cushion, and head restraint 32 foam stiffness, and the width of the seat. Once the parameters are selected, an optimization range is determined for each parameter. Then, a dummy 40 is selected, typically from the 50^{th} percentile, but in the instant application of the method, the 5^{th} and the 95^{th} percentiles were also used. Next, optimization is carried out on a single parameter from the list. Each parameter is allowed to “move” within the predetermined range during this process, with the optimization being geared to the specific criterion to be met. Once every parameter is moved along its range, each parameter is checked for significance with respect to the specific criterion (in this case, neck loads and moments). Any parameters having little or no significance are discarded and no longer considered in later phases of testing/optimization. Optimization runs are then carried out with combinations of the remaining parameters to determine ideal ranges for each of the parameters, especially when tested in conjunction with each other. These parameters and ranges are then used in later phases of testing.

The sixth phase 20 of the current application of the method uses a finite element model (FEM) build 70 of the seat assembly 30. Unlike the multibody build 60, a FEM build 70 is very detailed as it goes beyond the surface of the seat assembly 30 to every part of the assembly, taking into account the properties of the different materials. Accordingly, due to this additional detail, it takes much longer to run assimilations on the FEM model 70 than on the multibody build 60.

The sixth phase 20 of the current application of the method involves the building of the finite element model 70. There are four steps to the model building process: the seat geometry, the material properties, the dummy 40 positioning, and the dummy 40-to-seat contacts. The first step is building the seat geometry. The seat structure is obtained through CAD data and the seat components are then meshed with solid, shell, beam and truss elements as necessary. Those components are then connected together by rigid bodies, spot welds, etc. Finally, the seat back 34, track 38, and head restraint 32 are connected and positioned based on the data from the sled test.

For the second step of the build, determining the material properties, the seat components are assigned material properties based on Bill of Material, material property charts, and related reference data commonly available in the industry. The seat structure components are then assigned thicknesses and other properties based on this data.

The third step of the build involves positioning the dummy 40 according to the data from the original sled test and H-point information. This process is the same as the process described for positioning the dummy 40 into the multibody build 60 in phase three; therefore, refer to the description above for this step of the build.

The fourth step of the model build 70 involves ensuring that the correct contacts are being made between the dummy 40 and the seat model 70. Again, with only one addition, the contacts used in the multibody build 60 are the same as they are here. The one addition for the FEM build 70 is to ensure that the contacts between the seat components with each other are correct. Once this is completed, the FEM model 70 is built and must be verified.

The seventh phase 22 of the current application of the method involves validating the FEM build 70 to ensure that the build is substantially the same as the physical seat assembly 30 used in the sled test. First, signals from the dummy 40 in both the sled test and the simulated rear impact must correlate. The signals used may vary in different applications of this method, but in the current application, the signals considered included: head 42 longitudinal and vertical accelerations, chest 46 longitudinal accelerations, pelvis 52 longitudinal accelerations, upper and lower neck 44 shear and axial loads, and upper and lower neck 44 moments about the y-axis. Next, it is necessary to tune the seat back 34 foam and the head restraint 32 foam stiffness properties so as to get the timings and the value of the peak longitudinal head 42, chest 46 and pelvis 52 accelerations of the model 70 to correlate with the sled test data. Also, in the instant application, friction and damping functions were introduced in the model 70 based on referenced rear impact studies and were tuned for correlation to the sled test. In this application, the correlation between the test and the model 70 was considered acceptable and the model was verified if the model response trend was similar to the sled test and when the peak loads were within 15-20% of the tests with respect to magnitude and timings. One in the art will realize that the correlation percentage may be modified for other applications of this method.

The eighth phase 24 of the current application of the instant method involves modifying and optimizing the FEM build 70. In this phase, the same optimization method as described in phase five for the multibody build 60 is used to further test those parameters; however, this time only those parameters deemed significant after the multibody 60 testing are optimized. After running the optimizations on each individual parameter, those that have little or no significance to the target outcome are discarded. Next, carry out the rear impact analyses with combinations of the remaining parameters to determine the best ranges and combinations. Often, after this stage, there will be two or three possible solutions. At this time, it is necessary to choose one solution based on best results and also considering the impact of the proposed changes to the manufacturing cost, weight analysis, and impact on other regulations and requirements. Once one solution is chosen, the next step is to modify the physical seat assembly 30 for a final sled test.

The ninth phase 26 of the current application of the instant method involves rebuilding the seat prototype 30 to reflect the changes suggested in the previous phase. Finally, the tenth phase 28 of the current application of the method involves a final sled test to certify the seat 30. The rear impact sled test is carried out at the selected impact pulse with the modified seat 30 and the appropriate dummy 40. Preferably, multiple tests should be carried out using the same setup to ensure the repeatability of the data. The parameters and type of data obtained from the test should be identical to those obtained in the initial sled test in phase one of the application.

In sum, this method involves running a sled test to obtain data, or already having such data from a prototype 30, to create a basic model 60 of the prototype 30 for simulation software. Simulations are run on the model 60 to determine which parameters are significant to the desired outcome. This basic model 60 allows for quick simulations and therefore more experimentation to determine which parameters are significant to the desired outcome. Once those significant parameters are identified, a detailed build 70 is created and again, simulations are run to further determine the most significant parameters and ranges for those parameters. The best solution is then chosen, the seat prototype 30 is rebuilt/modified according to the solution, and a final sled test is run. One skilled in the art will realize that the process significantly reduces development cost and time by reducing the number of sled tests and by only running the detailed and time intensive assimilations on parameters known to be significant to the outcome.

The invention has been described in an illustrative manner, and it is to be understood that the terminology which has been used, is intended to be in the nature of words of description rather than of limitation.

Many modifications and variations of the present invention are possible in light of the above teachings. It is, therefore, to be understood that within the scope of the appended claims, the invention may be practiced other than as specifically described.

What is claimed is:

1. A method of designing seat assemblies for meeting a desired objective using a prototype seat assembly, a test dummy, and simulation software, said method comprising the steps of:
building a basic model of the prototype seat assembly surface using the simulation software;
identifying a plurality of seat parameters for designing the seat assembly;
determining which seat parameters are most significant to meeting the desired objective by running simulations on the basic model;
building a detailed model of the seat assembly using simulation software for a more accurate representation of the seat assembly;
determining which of the seat parameters are most significant to meeting the desired objective by running simulations on the detailed model;
optimizing the most significant parameters to best meet the desired objective; and
modifying the prototype seat assembly according to the results of optimizing the most significant parameters.

2. A method as set forth in claim 1, wherein the step of determining which seat parameters of the basic model are most significant to meeting the desired objective by running simulations on the basic model further includes the steps of:
identifying the seat parameters with the potential to influence the test dummy in rear impacts;
determining the optimization range for each of the identified seat parameters;
optimizing each of the identified seat parameters separately;
determining the overall significance of each of the identified seat parameters;
disregarding the identified seat parameters having little or no significance in meeting the desired objective; and
determining ideal ranges for each of the significant seat parameters when combined with the other significant seat parameters.

3. A method as set forth in claim 2, wherein the step of determining which of the seat parameters are most significant to meeting the desired objective by running simulations on the detailed model further includes the steps of:
identifying the seat parameters previously determined to be significant to the rear impact performance of the basic model of the seat assembly;
optimizing each of the seat parameters separately by running simulations on the detailed build;
determining the overall significance of each of the seat parameters; and
disregarding any seat parameters having little or no significance in meeting the desired objective.

4. A method as set forth in claim 3, wherein the step of optimizing the most significant parameters to best meet the desired objective further includes the steps of:
identifying the seat parameters previously determined to be most significant to meeting the desired objective;
running simulations on the detailed model with various combinations of the most significant seat parameters to determine the best combinations and ranges of those seat parameters; and
choosing one best combination for meeting the desired objective of the seat assembly.

5. A method as set forth in claim 4, further including the step of running a sled test on the provided prototype seat assembly with the provided test dummy to obtain the data necessary to create an accurate model of the seat assembly using the simulation software.

6. A method as set forth in claim 5, further including the step of running component level tests on the prototype seat assembly to provide the data required as input properties to build a model of the seat assembly using the simulation software.

7. A method as set forth in claim 6, further including the step of validating the basic model with the sled test data to ensure accurate modeling of the prototype seat assembly.

8. A method as set forth in claim 7, further including the step of validating the detailed model with the sled test data to ensure accurate modeling of the prototype seat assembly.

9. A method as set forth in claim 8, further including the step of running a final sled test on the modified prototype seat assembly with the test dummy to obtain the data necessary to show advancement towards the desired objective.

10. A method of designing seat assemblies to improve rear impact performance using a prototype seat assembly, a test dummy, and simulation software, said method comprising the steps of:
running a sled test on the provided prototype seat assembly with the provided test dummy to obtain the data necessary to create an accurate model of the seat assembly using the simulation software;
building a basic model of the prototype seat assembly surface using the simulation software;
validating the basic model with the sled test data to ensure accurate modeling of the prototype seat assembly;
identifying a plurality of seat parameters for designing the seat assembly;
determining which seat parameters of the basic model are most significant to meeting the desired objective by running simulations on the basic model;
building a detailed model of the seat assembly using the simulation software for a more accurate representation of the seat assembly;
validating the detailed model with the sled test data to ensure accurate modeling of the prototype seat assembly;
determining which of the seat parameters are most significant to meeting the desired objective by running simulations on the detailed model;
optimizing the most significant parameters to best improve rear impact performance;
modifying the prototype seat assembly according to the results of optimizing the most significant parameters; and
running a final sled test on the modified prototype seat assembly with the test dummy to obtain the data necessary to show advancement towards improving rear impact performance.

11. A method as set forth in claim 10, further including the step of running component level tests on the prototype seat assembly to provide the data required as input properties to build a model of the seat assembly using the simulation software.

12. A method as set forth in claim 11, wherein the step of building a basic model of the seat assembly surface on the simulation software further includes the steps of:
modeling the seat geometry;
determining the joint properties;
modeling the foam and suspension stiffness;
positioning the test dummy into the modeled seat assembly; and
validating the contact points between the test dummy and the modeled seat assembly.

13. A method as set forth in claim 12, wherein the step of determining which seat parameters of the basic model are most significant to meeting the desired objective further includes the steps of:
identifying the seat parameters with the potential to influence the test dummy in rear impacts;
determining the optimization range for each of the identified seat parameters;
optimizing each of the identified seat parameters separately;
determining the overall significance of each of the identified seat parameters;
disregarding the identified seat parameters having little or no significance on the rear impact performance of the basic model; and
determining ideal ranges for each of the significant seat parameters when combined with the other significant seat parameters.

14. A method as set forth in claim 13, wherein the step of building a detailed model of the seat assembly on the simulation software further includes the steps of:
modeling the seat geometry;
determining the material properties for the seat structure components;
positioning the test dummy according to sled test data; and
validating the contact points between the test dummy and the modeled seat assembly.

15. A method as set forth in claim 14, wherein the step of determining which of the seat parameters of the detailed model are most significant to meeting the desired objective further includes the steps of:
identifying the seat parameters previously determined to be significant to the rear impact performance of the basic model of the seat assembly;
optimizing each of the seat parameters separately by running simulations on the detailed build;
determining the overall significance of each of the seat parameters; and
disregarding any seat parameters having little or no significance in influencing the test dummy in a simulated rear impact on the detailed model.

16. A method as set forth in claim 15, wherein the step of optimizing the most significant parameters to best improve rear impact performance further includes the steps of:
identifying the seat parameters previously determined to be most significant to the rear impact performance of the detailed model;
running simulations on the detailed model with various combinations of the most significant seat parameters to determine the best combinations and ranges of those seat parameters; and
choosing one best combination for improving the rear impact performance of the seat assembly.
